(19) United States
(12) Patent Application Publication
(10) Pub. No.: US 2022/0128581 A1
(43) Pub. Date: Apr. 28, 2022

(54) Systems and Methods for Controlled Dispensing of Temperature-Sensitive Fluids in Liquid Handling and Dispensing Systems

(71) Applicant: Cellink AB, Göteborg (SE)

(72) Inventors: Hector Martinez, Göteborg (SE); Erik Gatenholm, Göteborg (SE); Adam Micha, Gråbo (SE); Erik Sternå, Mölndal (SE); Christopher Laske, Heilbad Heiligenstadt (DE)

(21) Appl. No.: 17/430,047

(22) PCT Filed: Feb. 13, 2020
(86) PCT No.: PCT/EP2020/053721

§ 371 Date: Aug. 11, 2021

Related U.S. Application Data
(60) Provisional application No. 62/806,521, filed on Feb. 15, 2019.
(60) Provisional application No. 62/876,352, filed on Jul. 19, 2019.

(30) Foreign Application Priority Data
Feb. 20, 2019 (SE) 1950214-5

(51) Int. Cl. G01N 35/00; B29C 64/209; B29C 64/25; B29C 64/245; B29C 64/295; B33Y 30/00; B01L 3/02

(52) U.S. Cl. CPC G01N 35/00029; B29C 64/209; B29C 64/25; B29C 64/245; B29C 64/393; B33Y 30/00; B01L 3/022; B01L 3/0268; B29C 64/295

(57) ABSTRACT

The present disclosure relates to the field of liquid handling and dispensing systems in combination with additive manufacturing. In particular, it relates to temperature-controlled units, i.e. dispensing heads and source well holders, for receiving, holding and releasing liquid and semi-liquid material, liquid-handling and dispensing systems, apparatuses and methods for applying temperature-sensitive liquids. A temperature-controlled unit (1) comprises at least one Peltier element (3), each Peltier element having opposite first and second surfaces (4a, 4b). The unit (1) further comprises at least one cooling element (5). The at least one Peltier element (3) is arranged to have each respective first surface (4a) facing a reservoir block (2) of the unit (1). The at least one cooling element (5) is thermally connected to the Peltier element (3) and arranged to transfer heat generated by the at least one Peltier element (3) and dissipate the transferred heat away from the at least one Peltier element (3).

### TECHNICAL FIELD

The present invention relates to the field of liquid handling and dispensing systems in combination with additive manufacturing. In particular, it relates to temperature-controlled units, i.e. dispensing heads and source well holders, for receiving, holding and releasing liquid and semi-liquid material, liquid-handling and dispensing systems, apparatuses and methods for applying temperature-sensitive liquids.

### BACKGROUND ART

A liquid handling and dispensing system is a device, machine or equipment that is responsible for dispensing a fluid in controlled quantities and apply it on a desired area. Being able to precisely dispense fluids onto a specific point in a controlled way is a main characteristic of precision liquid handling and dispensing systems.

Precision liquid handling and dispensing systems can use either air pressure or positive displacement to dispense fluids in a controlled way. Air powered fluid dispensing system use air pressure that is outputted by an air compressor or a similar device and push on a piston or piston-like component that in turn push a fluid in a barrel out of the nozzle. Positive displacement liquid dispensing systems on the other hand do not use compressed air. They usually push a piston inside a barrel by means of a mechanical force that can be generated by electric stepper motors. They are ideal for instance for fluids that change viscosity over time generally and for precise control of flow rate and volume of the dispensed fluid.

Precision liquid handling and dispensing systems can be manually or automatically operated. They can be used in small volume and mass production applications.

Precision liquid handling and dispensing systems are used in various applications (e.g., electronics industry, automotive industry, life science industry) that demand accurate, uniform, process-controlled, and high throughput of repeatable depositions.

Precision liquid handling and dispensing systems are used in the life sciences in applications such as 1) liquid handling/dispensing of low (pL to nL range) and medium (microliter range) volumes of cell culture reagents, 2) compound dosing, 3) combinatorial dispensing, 4) titration, and 5) dispensing RNA samples for PCR analysis.

Examples for fluids that are used in precision fluid dispensing systems within the life science industry include cell culture reagents such as cell culture media, growth factors, cell culture ingredients, animal-derived supplements, non-animal origin supplements and hydrogels for 3D cell culture.

Heated toolheads or printheads, also called heated dispensing heads, are often used in additive manufacturing, also called 3D-printing, as well as in precision liquid handling and dispensing systems, because the heating function can allow the printability/dispensing of materials by increasing the temperature of the material above or close to its melting or gelation point to make it flow through a needle, nozzle or orifice to form a droplet and/or filament without clogging the nozzle. Additionally, non-heated dispensing heads are used in liquid handling and dispensing systems and 3D bioprinters to dispense polysaccharide hydrogels such as alginate, cellulose, xanthan gum, gellan gum, typically at a concentration below 1% w/w, as well as non-viscous cell culture reagents, such as cell culture media with and without growth factors and supplements. The above liquids and hydrogels can be processed and dispensed at room temperature (20° C. to 27° C.) for short (within minutes) and long (hours) periods of time without the fluid undergoing material decomposition, polymerization and/or crosslinking that may affect the dispensing accuracy and precision of the fluid/material/hydrogel.

Since many common hydrogels used for 2D and 3D cell culture require a cool temperature below 4° C. to be able to process them (e.g., pipetting liquid Matrigel® onto plastic tissue culture plates) over short (within minutes) and long (hours) periods without inducing the proteins to polymerize in the dispensing tip, which in turn affects the dispensing accuracy and precision, the ability to keep the temperature of the dispensing head/liquid reservoir stable and accurate over long periods of time (hours) is of utmost importance. Furthermore, the precise control of temperature and temperature range that is best suited for dispensing basement membrane matrices/hydrogels and the like at a high accuracy and precision for long periods of time and while keeping a sterile environment (e.g., working inside a regular-sized laminar flow hood bench) provides additional challenges that remain to be addressed. There is thus a need in the art for dispensing heads and liquid reservoirs in combination with precision liquid handling and dispensing systems or 3D bioprinters meeting the above mentioned challenges.

### SUMMARY OF THE INVENTION

The present invention can be used for multiple types of dispensing systems, liquid-handling systems, bioprinting systems and the like. Such dispensing systems can utilize a broad range of driving mechanisms to control the dispensing process of the fluid, namely: pneumatic-driven, mechanical-driven (i.e., positive displacement system like syringe pump), inkjet-driven (e.g., microvalve) and pressure-based driven (Immediate Drop on Demand Technology (I-DOT)). (Exemplary I-DOT systems are discussed in U.S. Pat. No. 8,759,113. The I-DOT uses a non-contact, pressure-based dispensing technology. By applying a well-defined pressure pulse on top of at least one source well with holes in the bottom of each well, a droplet is formed and a highly precise and accurate nanoliter droplet is released into any target well/plate. Larger volumes are achieved by applying up to 400 pulses per second. When there is no pressure pulse applied on the source well, no droplet is generated since capillary forces keep the sample liquid in the cavity.) The dispensing system can be used for dispensing low (water-like), medium (ketchup-like) and high (peanut butter-like) viscosity fluids that need to be dispensed in a controlled way (e.g., precise volume, flow rate, pressure). More precisely, it can be utilized to dispense extracellular matrix-derived solutions such as gelatinous protein mixtures, extracellular matrix proteins in solution (in acidic, neutral or basic pH), and basement membrane matrices such as Matrigel®, Geltrex® and Cultrex® Basement Membrane Extract, all of which are temperature-sensitive materials that require a low temperature (0° C. to 10° C.) for dispensing and/or bioprinting applications.

The present invention is used to dispense accurately temperature-sensitive fluids in a liquid handling and dispensing system so that to provide for a highly controlled dispensing of those fluids. As stated above, it can be applied to a wide variety of liquid handling and dispensing systems for a plethora of industrial applications and mostly in the life science field. The ability provided by this invention to accurately dispense temperature-sensitive solutions/materials/hydrogels such as basement membrane matrices in a liquid handling and dispensing system can also be beneficial in several other ways. For instance, knowing in real-time the fluid volume that has been dispensed or how much volume is left in the liquid reservoir/cartridge/syringe while dispensing, when e.g. utilizing the mechanical-driven (syringe pump) mechanism or the Immediate Drop on Demand Technology (I-DOT) to control the dispensing process of the fluid. Using a mechanical-driven mechanism, this is done by the user entering how much volume was loaded in the syringe and having a microcontroller record the total linear distance travelled by the plunger to calculate the volume dispensed (area of syringe is known, whereas height is recorded by microcontroller) and estimating how much fluid is left in the syringe and communicating this to the user through a graphical user interface in the dispensing system. Using the I-DOT mechanism this is done by the user entering how much volume was loaded in each reservoir/source well and having the droplet-detection technology record the total number of droplets and their volumes to calculate the volume dispensed and volume remaining in each reservoir/source well and communicating this to the user through a graphical user interface

Embodiments of the present invention provide systems and methods for control of temperature (<0° C. to 65° C., <0° C. to 10° C., preferably 0° C. to 4° C., or any range from below or from zero degrees Celsius to 65 degrees Celsius or more), volume (2 nL to 10 mL, 5 nL to 5 mL, 10 nL to 3 mL, 10 nL to 0.5 mL, or 1 μL to 100 μL) and flow rate (0.1 μL/s to 40 μL/s, preferably 1 μL/s to 20 μL/s depending on the volume dispensed) of a temperature-controlled unit for receiving, holding and releasing a liquid or semi-liquid material arranged inside a dispensing chamber.

The present disclosure relates to regulation of a temperature of a unit for receiving, holding and releasing liquid or semi-liquid material. The temperature-controlled unit comprises at least one Peltier element. Each Peltier element has opposite first and a second surfaces. The printhead further comprises at least one cooling element. The at least one Peltier element is arranged to have each respective first surface facing a print surface of the printhead. The at least one cooling element is thermally connected to the Peltier element and arranged to transfer heat generated by the at least one Peltier element and dissipate the transferred heat away from the at least one Peltier element. The disclosed unit provides a means for both regulating the temperature up and down about a desired temperature. The ability to switch from heating to cooling enables improved temperature regulation over conventional heating printheads only arranged to increase the temperature when needed, and thus making them (heated printheads) incapable in dispensing extracellular matrix-derived solutions.

According to some aspects, the cooling element is a heatsink. In such case the temperature-controlled unit may further comprise at least one fan. The at least one fan is arranged to transport the heat from the at least one heatsink, which is thermally connected to the Peltier element, to dissipate the transferred heat away from the at least one Peltier element. In one configuration, the at least one fan (next to each other or stacked fans) is arranged to suck in air towards the at least one heatsink via the front fan, through the at least one heat sink, and ultimately away from the at least one heatsink. In another configuration, the at least one fan is arranged to suck out air from the at least one heatsink via the front fan, through the at least one heat sink, and ultimately away from the at least one heatsink. The fan enables efficient transport the hot air, away from the heat sink, thereby preventing a buildup of unwanted heat in the vicinity of the temperature-controlled unit.

According to some further aspects, the at least one fan comprises top and bottom fans, wherein the first fan may be arranged at the bottom side of the heatsink and the second fan may be arranged at the top side of the heatsink. The top and bottom fans are opposite each other and preferably arranged to align along the fan axis. The bottom fan is arranged to suck in air from the bottom towards the at least one heatsink, through the at least one heat sink, and ultimately away from the at least one heatsink via the top fan. This fan configuration also enables efficient transport of hot air, away from the heat sink, thereby preventing a buildup of unwanted heat in the vicinity of the temperature-controlled unit.

In alternative embodiment, the cooling element of the temperature-controlled unit is at least one liquid cooling unit. The at least one liquid cooling unit (e.g. radiator) is arranged to be thermally connected to the Peltier element to dissipate the transferred heat away from the at least one Peltier element by circulating a liquid coolant such as but not limited to water, deionized water, ethylene glycol solution, betaine inside the liquid cooling system. This configuration is more efficient than using fans and heatsinks to remove the heat away from the Peltier element. However, it is much more bulky due to the pipes or tubes that run from the heater exchange to the liquid circulation system and might require more maintenance such as frequent refill or replacement of the liquid coolant.

The temperature-controlled unit may in one embodiment be a dispensing head.

The dispensing head may be a positive displacement dispensing head arranged to control (a) temperature, (b) volume and (c) flow rate for dispensing small volumes with high accuracy and precision of the fluid being dispensed.

The dispensing head may be an inkjet driven dispensing head.

The temperature-controlled unit may in another embodiment be a source well holder (fluid reservoir holder) for at least one source well arranged to receive a temperature-sensitive liquid and from which the liquid is dispensed. The source well holder may hold a plurality of source wells that are open at an upper end, wherein respective bases opposite the upper end have an orifice, where the orifice is configured in such a manner that capillary pressure in the respective orifice is greater than a pressure which can be produced by the liquid in the respective source well. A plurality of source wells may be the wells of one or more micro titer plates.

The source well holder may comprise at least one non-contact, pressure-driven, immediate drop on demand technology (I-DOT).

The present disclosure also relates to a liquid handling and dispensing system comprising a dispensing chamber, with or without environmental control (e.g., temperature, humidity, HEPA filtration system), which also comprises at least one temperature-controlled unit (dispensing head or source well holder) as described above and below. The at least one temperature-controlled unit is arranged inside the dispensing chamber. The liquid handling and dispensing system has all the technical effects and advantages of the disclosed temperature-controlled unit.

According to some aspects, the dispensing chamber is small enough to be placed inside a standard Laminar Flow Hood bench for operation. The size of the liquid handling and dispensing system is less than 1 m³ and preferably less than 0.125 m³ (0.5×0.5×0.5 m). This makes the liquid handling and dispensing system particularly suitable for printing of organic materials with or without living cells in a sterile environment.

The present disclosure also relates to a method for regulating a temperature of a temperature-controlled unit arranged for receiving, holding and releasing liquid or semi-liquid material. The temperature-controlled unit is a temperature-controlled unit according to the present disclosure. The method comprises applying, at least one of the at least one Peltier element, a first voltage having a first polarity. The first voltage is arranged to cause a temperature at the first surface of at least one of the at least one Peltier elements to decrease.

According to some aspects, the method further comprises applying, at least one of the at least one Peltier element, a second voltage having a second polarity opposite the first polarity. The second voltage is arranged to cause the temperature at the first surface of at least one of the at least one Peltier elements to increase.

According to some aspects, the method further comprises comparing the temperature at the first surface to a desired temperature, and adjusting the temperature by applying a voltage having a polarity based on the comparison.

By regulating the temperature up and down, greater control and flexibility of the unit temperature is enabled. For instance, a desired temperature can be reached more quickly without fear of overshooting. Furthermore, deviations from the desired temperature can be adjusted in both directions, up and down, enabling better precision and a more stable temperature of the fluid material inside the temperature-controlled unit.

The present disclosure also relates to an apparatus for applying temperature-sensitive liquids on one or more target plates, comprising: a temperature-controlled source well holder described above; a mechanism for producing a gas pressure pulse disposed above the source well holder and in fluid communication with the respective upper end of at least one or several but not all of the source wells to receive the gas pressure pulse; a holder for at least one target plate capable of being disposed below the temperature-controlled source well holder; at least one moving mechanism for moving or rotating the source well holder relative to the at least one element producing a gas pressure pulse, and/or vice versa; and at least one moving mechanism for moving the target plate holder relative to the at least one source well holder, and/or vice versa.

The disclosure also relates to a method for applying liquids on target plates, comprising: simultaneously supplying at least one source well with a pressure pulse by a mechanism for producing a pressure pulse, wherein: a temperature-controlled source well holder includes one or more source wells for receiving a liquid and from which the liquid is dispensed, the source well holder comprising a plurality of source wells that are open at an upper end, wherein respective bases opposite the upper end have an orifice, where the orifice is configured in such a manner that capillary pressure in the respective orifice is greater than a pressure which can be produced by the liquid in the respective source well; a mechanism for producing a gas pressure pulse disposed above the source well holder and in fluid communication with the respective upper end of at least one or several but not all of the source wells to receive the gas pressure pulse; a holder for at least one target plate is disposed below temperature-controlled source well holder; at least one moving mechanism for moving or rotating the source well holder relative to the at least one element producing a gas pressure pulse; and at least one moving mechanism for moving the target plate holder relative to the at least one source well holder.

### BRIEF DESCRIPTION OF THE DRAWINGS

FIG. 1 is a schematic drawing of the disclosed temperature-controlled unit for receiving, holding and releasing liquid or semi-liquid.

FIG. 2 is a schematic drawing of the disclosed temperature-controlled dispensing head showing a first fan arranged at the bottom side of the cooling element being a heatsink and the second fan arranged at the top side of the heatsink. The bottom fan is arranged to suck in air from the bottom towards the at least one heatsink, through the at least one heat sink, and ultimately away from the at least one heatsink via the top fan, according to embodiments of the invention.

FIG. 3 is a schematic drawing of the disclosed temperature-controlled source well holder showing a first fan arranged at the bottom side of the cooling element being a heatsink and a second fan arranged at the top side of the heatsink. The bottom fan is arranged to suck in air from the bottom towards the at least one heatsink, through the at least one heat sink, and ultimately away from the at least one heatsink via the top fan, according to embodiments of the invention.

FIG. 4 illustrates a schematic drawing of the disclosed liquid handling and dispensing system comprising the temperature-controlled unit according to the present disclosure.

FIG. 5 illustrates a 3D wireframe drawing of the disclosed apparatus for applying temperature-sensitive liquids on one or more target plates, comprising temperature-controlled source well holder, at least one source well, a target plate and a heated target plate holder, according to the present disclosure.

FIG. 6 illustrates a 3D render of the disclosed apparatus with temperature-controlled source well holder and at least one source well, according to the present disclosure.

FIG. 7 is a graph that shows the temperature stability of the temperature-controlled dispensing head being a positive displacement dispensing head over 13 hours of continuous operation at a set temperature of 0° C. Multiple experiments were conducted by loading 3 mL of varying concentrations of Matrigel® solutions (5, 7, 9, 15 and 18% solid content) in a 3 mL syringe and a digital thermometer was utilized to record the temperature of the fluid at the center of the syringe. Temperature measurements shown for 9% Matrigel® solution.

FIG. 8 is a chart that shows the dispensing accuracy and precision of the temperature-controlled dispensing head being a positive displacement head when dispensing droplets of Matrigel® solution (9% solid content) at different target volumes (5, 10 and 50 μL). 24 samples per experiment.

FIG. 9 are images that show examples of droplets of Matrigel® solution (9% solid content) dispensed by liquid handling and dispensing system comprising a temperature-controlled, positive displacement dispensing head. 10 μL droplets were dispensed in 96 wellplates (left). 50 μL droplets were dispensed in 24 wellplates (right).

FIG. 10 is a graph that shows the temperature stability of the temperature-controlled source well holder over 12 hours of continuous operation at a set temperature of 0° C. Multiple experiments were conducted by loading 0.5 mL of varying concentrations of Matrigel® solutions (5%, 7%, 9%, 15% and 18% solid content) in a 0.5 mL source well and a digital thermometer was utilized to record the temperature of the fluid at the center of the source well. Temperature measurements are shown for 9% Matrigel® solution.

### DETAILED DESCRIPTION OF VARIOUS EMBODIMENTS OF THE INVENTION

Reference will now be made in detail to various exemplary embodiments of the invention. It is to be understood that the following discussion of exemplary embodiments is not intended as a limitation on the invention. Rather, the following discussion is provided to give the reader a more detailed understanding of certain aspects and features of the invention.

### Definitions

The following definitions are provided to facilitate understanding of certain terms provided in this specification. For other terms not defined herein, the ordinary meaning as recognized by an ordinarily-skilled artisan should be applied.

Liquid Handling and Dispensing System: Liquid handling and dispensing systems include all types of devices, systems and equipment that dispense, mix and dispense, or mix, meter, and dispense dispensing contents, such as fluid media. In addition, it includes precise systems that accurately dispense media in a controlled and repetitive manner controlled by processing and/or controlling elements. The range of applications that use such liquid handling and dispensing systems and materials is wide and varied. Liquid handling and dispensing system is also used in this text to describe a biodispensing system.

Processing Element: A processing element (or “processor” as used interchangeably herein) is an electronic circuitry or an integrated circuit within a computer or an electronic system that carries out the instructions of a computer program by performing the basic arithmetic, logical, control and input/output (I/O) operations specified by the instructions. Microprocessors mean they are contained on a single integrated circuit (IC) chip. An IC that contains a CPU may also contain memory, peripheral interfaces, and other components of a computer; such integrated devices are variously called microcontrollers or systems on a chip (SoC). Some systems employ a multi-core processor, which is a single chip containing two or more processing units called “cores”.

Control Element: The control element can comprise an analog circuitry and/or digital units in order for it to control the function of a system. An example for a digital controller is a microcontroller chip. A microcontroller contains one or more CPUs (processor cores) along with memory and programmable input/output peripherals. Microcontrollers are used in automatically controlled products and devices, such as automobile engine control systems, implantable medical devices, remote controls, office machines, appliances, power tools, toys and other embedded systems. Other examples for control elements include proportional-integral-derivative (PID) controller, system on a chip, computer, processor unit, central processing unit and embedded controller unit.

Air Powered Liquid Handling and Dispensing System: An air powered liquid handling and dispensing system is a system that uses air pressure that is outputted by a pump or a similar device and push on a piston or piston-like component that in turn push a fluid in a barrel/reservoir/cartridge/source well out of the nozzle/orifice.

Positive Displacement Dispensing System: A positive displacement dispensing system is a system that pushes a piston inside a barrel/reservoir/syringe by means of a mechanical force that can be generated by electric stepper motors. They are ideal for instance for two-part epoxies and fluids that change viscosity over time generally.

Precision Liquid Handling and Dispensing System: Precision liquid handling and dispensing systems are systems that are capable of precisely dispensing fluids onto a specific point in a controlled way.

Source Well: A source well is a fluid reservoir with a hole at the bottom of each well. This unit is capable of holding and releasing and/or dispensing and/or depositing a liquid and or semi-liquid material onto a target plate only when a well-defined pressure pulse is applied on top of the source well in order to form a highly precise and accurate nanoliter droplet and make 3D multi-layered structures in a controlled and precise way. Larger volumes are achieved by applying up to 400 pulses per second. When there is no pressure pulse applied on the source well, no droplet is generated since capillary forces keep the sample liquid in the cavity. A source well can be made out of polymers (e.g., polypropylene), metals (e.g., aluminum, copper) and/or glass.

Source Well Holder: A source well holder is a mechanical holder for at least one source well. A plurality of source wells may for example be the wells of a titer plate. It offers a close contact with the source well to ease the heat transfer when cooling and or heating of the liquid in the source well is required. The source well holder can be integrated with a temperature control unit for cooling and/or heating.

3D Printer: A 3D printer is a computer-aided manufacturing (CAM) device that is capable of creating three-dimensional objects. 3D printers use a process called additive manufacturing to make 3D physical objects layer by layer until the model is complete. Examples for technologies used for 3D printing include stereolithography (SLA) and fused deposit modeling (FDM).

3D Bioprinter: A 3D bioprinter utilizes 3D printing and 3D printing-like techniques to combine cells, growth factors, and biomaterials to fabricate tissue-like or tissue analogue structures that imitate natural tissue characteristics.

Generally, 3D bioprinting utilizes the layer-by-layer method to deposit/dispense dispensing contents, such as materials known as bioinks or hydrogel to create tissue-like structures that are later used in life science and tissue engineering fields. Bioprinting covers a broad range of biomaterials or bioinks.

Dispensing head: A dispensing head is a unit that is capable of releasing and/or dispensing and/or depositing and/or printing material onto the printbed in order to make droplets, filaments and/or 3D multi-layered structures in a controlled and precise way.

Bioink: Bioinks are mostly fluid materials or hydrogels that can be dispensed by printheads to be deposited on a printbed to build layer-by-layer 3D structures. They provide appropriate environment for cell growth and can be used to create tissue-like structures that are later used in the life science and tissue engineering fields. Examples of bioinks include: extracellular matrix-derived solutions (e.g., gelatinous protein mixtures, extracellular matrix proteins in solution, and basement membrane matrices), polysaccharide hydrogels (e.g., alginate, cellulose, xanthan gum, gellan gum), gelatin, and agarose, to name a few.

ECM Hydrogel: ECM hydrogels are extracellular matrix-derived solutions such as gelatinous protein mixtures, extracellular matrix proteins in solution (in acidic, neutral or basic pH), and basement membrane matrices such as Matrigel®, Geltrex® and Cultrex® Basement Membrane Extract, all of which are temperature-sensitive materials that require a low temperature (0° C. to 10° C.) for dispensing. For 3D cell culture applications, they provide appropriate environment for cell growth and can be used to create tissue-like structures that are later used in the life science fields.

Polysaccharide hydrogels: Polysaccharide hydrogels are polysaccharide-derived materials in dispersion (in acidic, neutral or basic pH) and may or may not require temperature control for dispensing and are also used in 3D cell culture applications. Examples of polysaccharide hydrogels include: alginate, cellulose, xanthan gum, gellan gum, gelatin, and agarose.

Printing Parameters of Bioinks: Printing parameters of bioinks include applied pressure, flow rate, translation speed of the printhead during the printing process, temperature of the bioink, temperature of the print surface, layer height, infill pattern and density, the nozzle diameter, nozzle shape, and nozzle material.

Dispensing Parameters of Hydrogels: Dispensing parameters of hydrogels include applied pressure, magnitude of pressure pulse, frequency of pressure pulse, translation speed of the source well and/or target plate during the dispensing process, temperature of the hydrogel, temperature of the target well/plate and source well orifice diameter.

Droplet: A droplet is a structure that is formed when a bioink, for example, a bioink, is extruded at a single location on the print surface. The printhead does not translate in the x-y plane (where the x-y plane is the print surface), only in the z-direction, if necessary. Depending on the composition of the bioink, the resultant shape is typically circular or eclipse in shape when observed from above with an eccentricity between 0 and 1.

Printed Filament: A printed filament is a structure that is formed when a bioink is extruded across the print surface where the printhead translates along waypoints to result in a non-enclosed structure. The printhead translates in the x-y plane (where the x-y plane is the print surface), with the nozzle positioned above the surface in the z-axis at a height between 10% and 300% of the nozzle inner diameter. A printed filament structure typically has a minimum total length to width ratio of 1.

Geometric Structure: A geometric structure is a structure that is formed when a bioink is extruded across the print surface during printhead translation along waypoints and intersects or contacts the existing structure to enclose an area. The printhead translates in the x-y plane (where the x-y plane is the print surface), with the nozzle positioned above the surface in the z-axis at a height between 10% and 200% of the nozzle inner diameter. These geometric structures have a minimum of 0 vertices and 1 edge and enclose an area.

Multilayered Structure: A multilayered structure is a structure that is generated when a bioink is extruded on top of a previously deposited structure. The printhead translates in the x-y plane (where the x-y plane is the previously deposited structure), with the nozzle positioned above the previously deposited structure in the z-axis at a height between 10% and 200% of the nozzle inner diameter. Droplets, printed filaments, geometric shapes, and infill patterns can all be printed on the previously printed layer. The number of previously printed layers is a minimum of 1 to achieve the maximum build height set by the bioprinter system being utilized.

For purposes of this application, the terms “code”, “software”, “program”, “application”, “software code”, “software module”, “module” and “software program” are used interchangeably to mean software instructions that are executable by a processor.

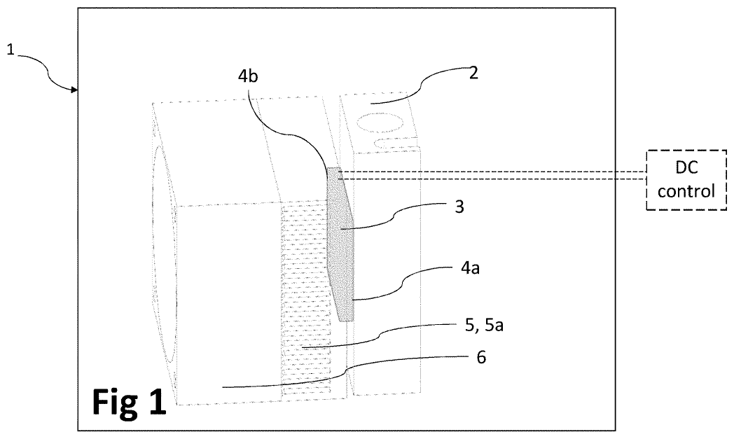

FIG. 1 illustrates a schematic drawing of the disclosed temperature-controlled unit for receiving, holding and releasing liquid or semi-liquid material.

Disclosed is a temperature-controlled unit 1 for receiving, holding and releasing liquid or semi-liquid material. The temperature-controlled unit comprises at least one Peltier element 3. Each Peltier element has opposite first 4a and second surfaces 4b. The temperature-controlled unit further comprises at least one cooling element 5. The at least one Peltier element is arranged to have each respective first surface facing a print surface of a reservoir block 2 of the temperature-controlled unit. The at least one cooling element is thermally connected to the Peltier element and arranged to transfer heat generated by the at least one Peltier element and dissipate the transferred heat away from the at least one Peltier element. The disclosed temperature-controlled unit provides a means for both regulating the temperature up and down about a desired temperature. The ability to switch from heating to cooling enables improved temperature regulation over conventional heat-capable liquid handling and dispensing systems only arranged to increase the temperature when needed, and thus making them incapable in holding and dispensing extracellular matrix-derived solutions.

The cooling element 5 may be a heatsink and the temperature-controlled unit may further comprise at least one fan 6 (as illustrated in e.g. FIG. 1) arranged stacked on the heat sink 5. The at least one fan 6 is arranged to transport the heat from the at least one heatsink 5, which is thermally connected to the Peltier element 3, to dissipate the transferred heat away from the at least one Peltier element. In one configuration, the at least one fan (next to each other or stacked fans) is arranged to suck in air towards the at least one heatsink via the front fan, through the at least one heat sink, and ultimately away from the at least one heatsink. In another configuration, the at least one fan is arranged to suck out air from the at least one heatsink via the front fan, through the at least one heat sink, and ultimately away from the at least one heatsink. The fan enables efficient transport the hot air, away from the heat sink, thereby preventing a buildup of unwanted heat in the vicinity of the temperature-controlled unit.

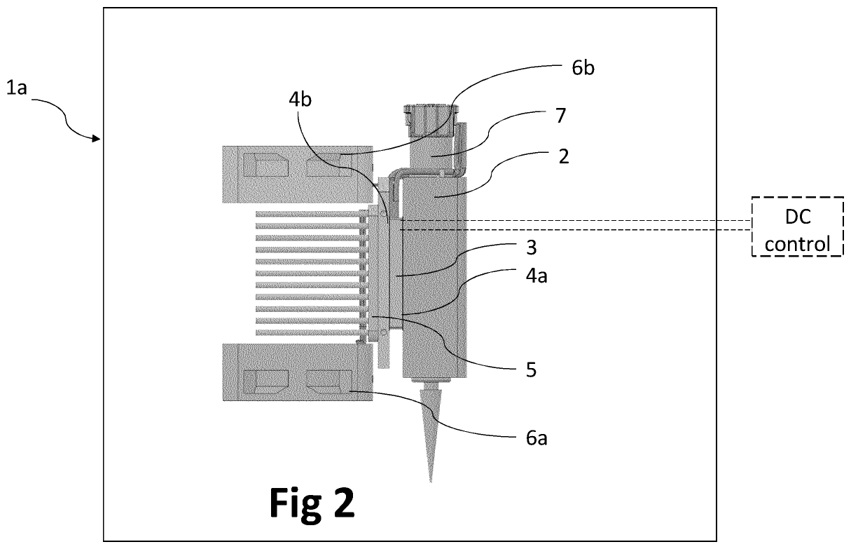

FIG. 2 is a schematic drawing of the disclosed temperature-controlled unit being a temperature-controlled dispensing head 1a showing the fan configuration, wherein the first fan 6a is arranged at the bottom side of the heatsink and the second fan 6b is arranged at the top side of the heatsink.

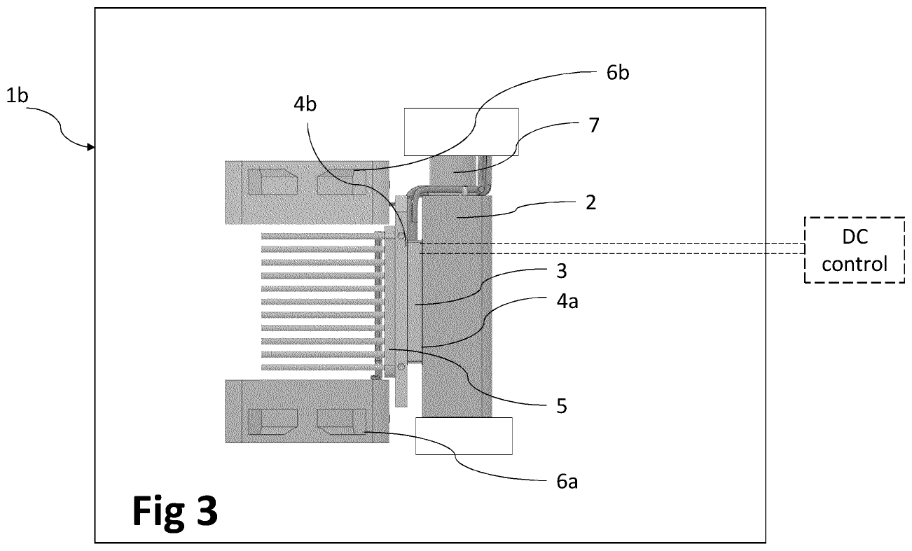

FIG. 3 is a schematic drawing of the disclosed temperature-controlled unit being a temperature-controlled source well holder 1b showing the fan configuration, wherein the first fan 6a is arranged at the bottom side of the heatsink and the second fan 6b is arranged at the top side of the heatsink. The source well holder 1b being arranged to hold at least one source well 7 for receiving a temperature-sensitive liquid and from which the liquid is dispensed, the source well holder 1b may hold a plurality of source wells that are open at an upper end, wherein respective bases opposite the upper end have an orifice, where the orifice is configured in such a manner that capillary pressure in the respective orifice is greater than a pressure which can be produced by the liquid in the respective source well.

The top and bottom fans 6a, 6b may be arranged opposite to each other and preferably arranged to align along the fan axis as shown in FIGS. 2, 3. The bottom fan is arranged to suck in air from the bottom towards the at least one heatsink, through the at least one heat sink, and ultimately away from the at least one heatsink via the top fan. This fan configuration also enables efficient transport of hot air, away from the heat sink, thereby preventing a buildup of unwanted heat in the vicinity of the dispensing head 1a/source well holder 1b, fluid reservoir/source well and/or printbed/target plate 10.

In an alternative embodiment, the cooling element 5 of the temperature-controlled unit 1, 1a, 1b is at least one liquid cooling unit 5a. The at least one liquid cooling unit (e.g. radiator) is arranged to be thermally connected to the Peltier element 3 to dissipate the transferred heat away from the at least one Peltier element by circulating a liquid coolant such as but not limited to water, deionized water, ethylene glycol solution, betaine inside the liquid cooling system. This configuration is more efficient than using fans 6 and heatsinks to remove the heat away from the Peltier element 3. However, it is much more bulky due to the pipes or tubes that run from the heater exchange to the liquid circulation system and might require more maintenance such as frequent refill or replacement of the liquid coolant. The embodiment is illustrated in FIG. 1 when without the fan 6.

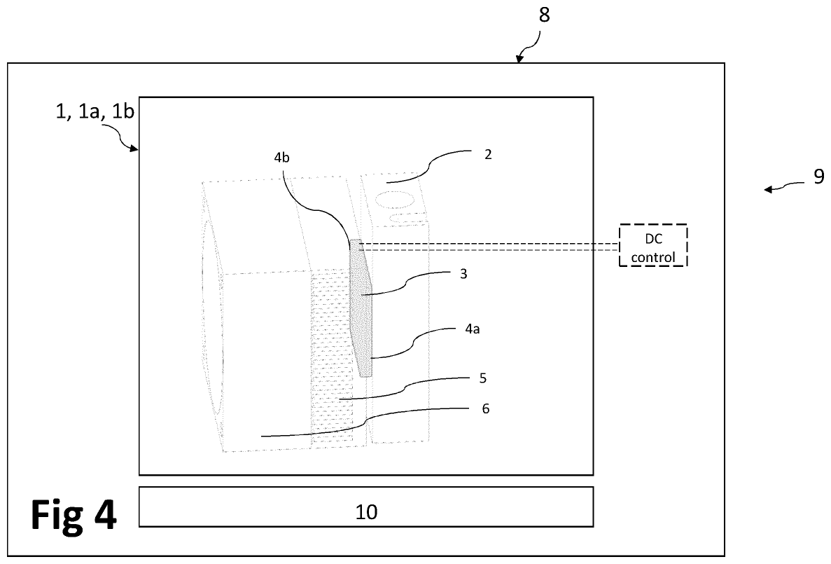

FIG. 4 illustrates a schematic drawing of a liquid handling and dispensing system 9 comprising at least one temperature-controlled unit 1, a temperature control dispensing head 1a or a temperature-controlled source well holder 1b, as described above and below. The liquid handling and dispensing system 9 further comprises a dispensing chamber 8 and a printbed/target plate 10. The at least one temperature-controlled unit is arranged inside the dispensing chamber. The liquid handling and dispensing system has all the technical effects and advantages of the disclosed temperature controlled unit 1, 1a, 1b.

According to some aspects, the dispensing chamber 8 is small enough to be placed inside a standard Laminar Flow Hood bench for operation. The size of the liquid handling and dispensing system is less than 1 m³ and preferably less than 0.125 m³ (0.5×0.5×0.5 m). This makes the liquid handling and dispensing system 9 particularly suitable for printing of organic materials with or without living cells in a sterile environment.

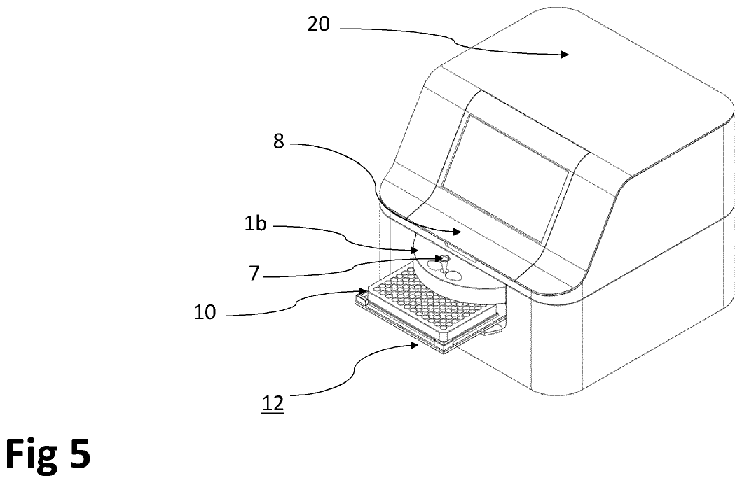

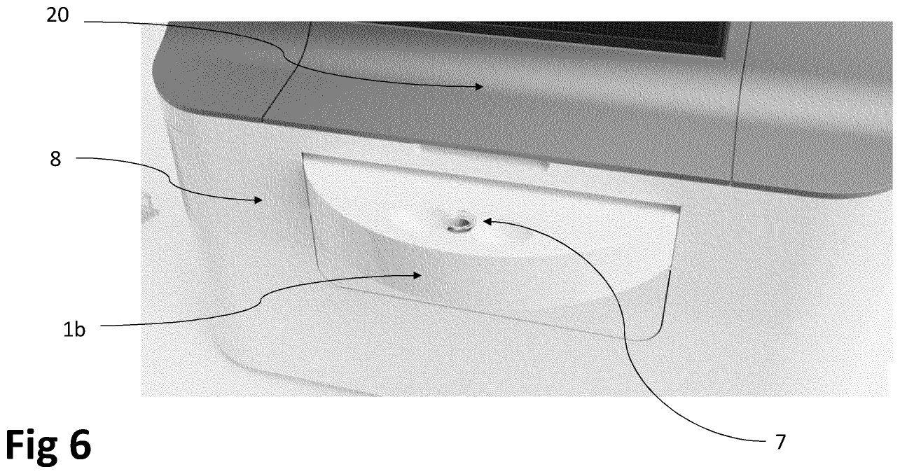

In FIGS. 5 and 6 an apparatus 20 for applying temperature-sensitive liquids on one or more target plates 10 is illustrated. The apparatus 20 comprising a temperature-controlled source well holder 1b, at least one source well 7, target plate 10 and heated target plate holder 12, according to the present disclosure. In embodiments, any number of source wells 7 can be used, including from 1-100. Even further, in embodiments the source well holder 1b can be configured to accommodate any number of source wells 7, including from 1-100, and can be configured to provide for placement of the source wells in any configuration relative to one another, such as in one or more linear or circular rows, including from 1-20 rows depending, for example, on the size of the instrument and the corresponding size of the source wells and/or the shape of the source wells. The source wells can be provided in any shape or size, and can all be the same or one or more of the source wells can be different in shape and/or size from others.

The apparatus 20 further comprises a dispensing chamber 8, with or without environmental control (e.g., temperature, humidity, HEPA filtration system). The at least one temperature-controlled source well holder 1b is arranged inside the dispensing chamber 11. The apparatus 20 has all the technical effects and advantages of the disclosed temperature-controlled source well holder 1b.

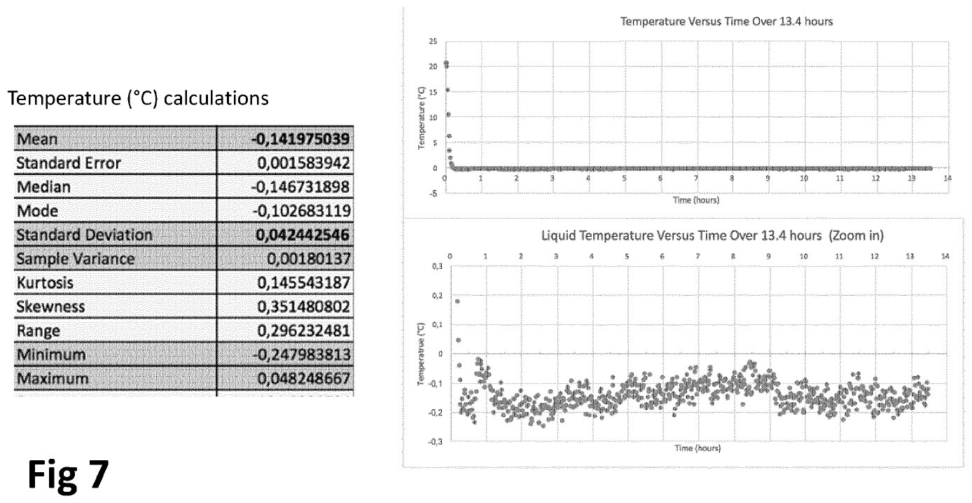

FIG. 7 shows the temperature performance of the temperature-controlled, dispensing head 1a being a positive displacement dispensing head while dispensing over long and continuous operation at a set temperature of about 0° C. Varying concentrations of Matrigel® solutions (5, 7, 9, 15 and 18% solid content) were loaded in the in a 3 mL syringe in placed inside the temperature-controlled, positive displacement printhead to record the temperature over time. From the temperature measurements shown for 9% Matrigel® solution, it can be seen that the temperature is stable and standard deviations of less than 0.05° C. are achieved with this dispensning head. Embodiments of the invention provide for temperature-controlled dispensing heads capable of maintaining a temperature within a range of +0.1 degrees, or within a range of +0.05 degrees, or within a range of ±0.5 degrees for a desired amount of time, such as for 1 minute, 5 minutes, 10 minutes, 30 minutes, 1 hour, 2-5 hours, 3-10 hours, 8-20 hours, 12-48 hours, 24-72 hours, 1-5 days, 2-10 days, 5-20 days, 8-30 days, 1-6 months, 2-8 months, 5-12 months, 1-5 years, 2-3 years, or more.

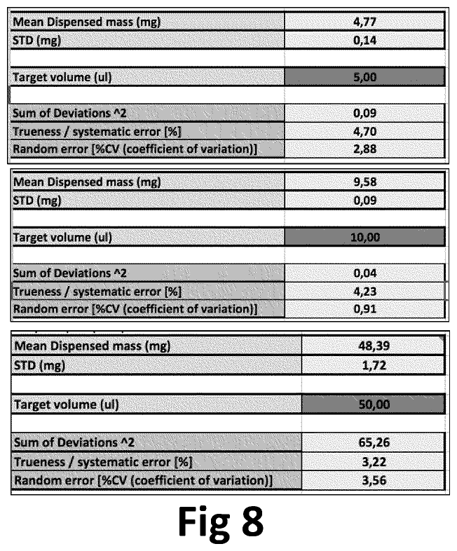

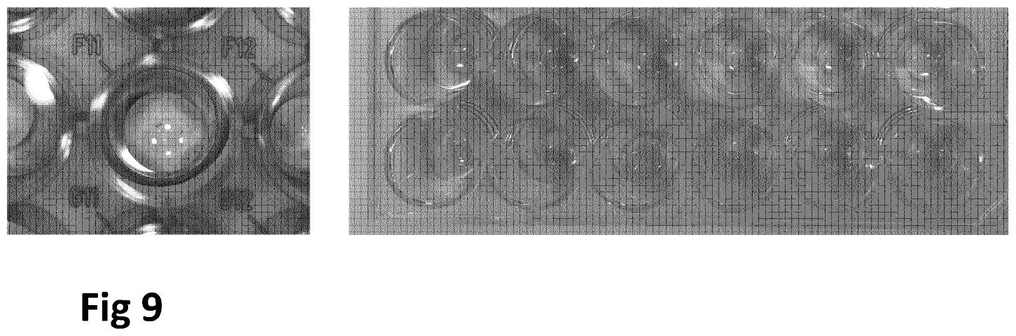

FIGS. 8 and 9 show the dispensing accuracy and precision of temperature-controlled, positive displacement dispensning head when dispensing droplets of Matrigel® solution (9% solid content) at different target volumes (5, 10 and 50 μL). The position of the droplets is controlled by the XY and Z gantry of the 3D bioprinter, whereas the volume, morphology and circularity of the droplets is controlled by the 3D bioprinter comprising at least one temperature-controlled, positive displacement dispensing head.

Droplets of Matrigel® solution (9% solid content) dispensed by the automated liquid handling system comprising a temperature-controlled source well holder show a similar dispensing result to what is shown in FIG. 9. The position of the droplets is controlled by the XY gantry of the target plate, whereas the volume, morphology and circularity of the droplets is controlled by the non-contact, pressure-based dispensing technology which applies a well-defined pressure pulse on top of a source well (with a hole in the bottom of each well) to form a highly precise and accurate nanoliter droplet that is released into any target well/plate.

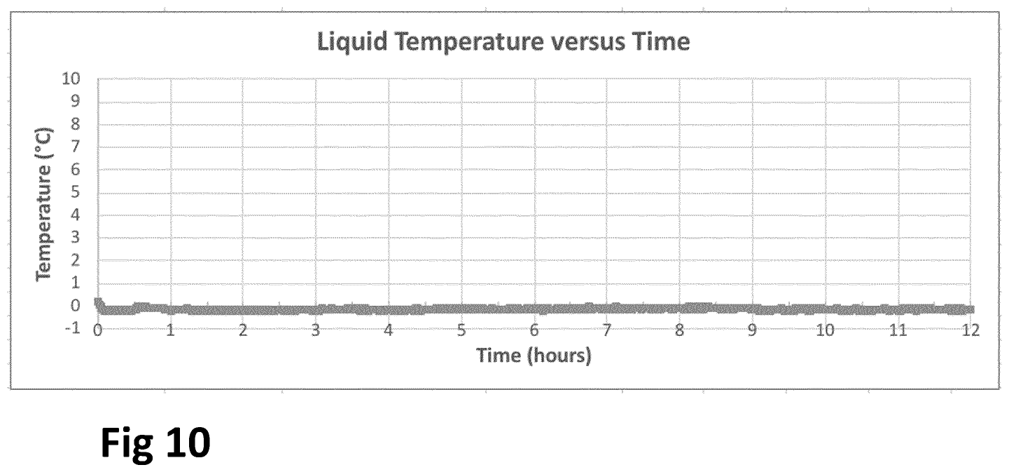

FIG. 10 shows the temperature performance of the temperature-controlled source well holder 1b while dispensing over long and continuous operation at a set temperature of 0° C. Varying concentrations of Matrigel® solutions (5%, 7%, 9%, 15% and 18% solid content) were loaded in the in a 0.5 mL source well placed inside the temperature-controlled source well holder to record the temperature over time. From the temperature measurements shown for 9% Matrigel® solution, it can be seen that the temperature is stable and standard deviations of less than 0.05° C. are achieved with this temperature-controlled source well holder configuration. Embodiments of the invention provide for temperature-controlled source well holders capable of maintaining a temperature within a range of ±0.1 degrees, or within a range of ±0.05 degrees, or within a range of ±0.5 degrees for a desired amount of time, such as for 1 minute, 5 minutes, 10 minutes, 30 minutes, 1 hour, 2-5 hours, 3-10 hours, 8-20 hours, 12-48 hours, 24-72 hours, 1-5 days, 2-10 days, 5-20 days, 8-30 days, 1-6 months, 2-8 months, 5-12 months, 1-5 years, 2-3 years, or more.

Embodiments of the liquid handling and dispensing system 9 and methods comprising the temperature-controlled dispensing head 1a are arranged for control of temperature (<0° C. to 65° C., <0° C. to 10° C., such as from −20 degrees Celsius to 20 degrees Celsius, or from −10 degrees Celsius to 5 degrees Celsius, preferably 0° C. to 4° C., or any range in between using any of these endpoints), volume (10 nL to 10 mL, preferably 1 μL to 100 μL) and flow rate (0.1 μL/s to 40 μL/s, preferably 1 μL/s to 20 μL/s depending on the volume dispensed) of at least one fluid reservoir inside at least one temperature-controlled dispensing head 1a, positive displacement dispensing head (i.e., temperature-controlled syringe pump dispensing head) that is integrated in a liquid handling and dispensing system 9. The temperature control range of 0° C. to 10° C. can be used to dispense extracellular matrix-derived solutions (e.g., gelatinous protein mixtures, extracellular matrix proteins in solution, and basement membrane matrices). However, when requiring precise and accurate dispensing of such fluids over a long period of time (>2 hours), a temperature range of 0° C. to 4° C. is better and a temperature range of 0° C. to 2° C. is preferred.

The dispensing head 1a configuration can also be with a pneumatic-driven and inkjet-driven dispensing mechanism. Limitations of the pneumatic-driven dispensing head include the time-consuming calibration of the fluid as well as a suboptimal temperature control due to the continuous exchange of compressed air at the top of the cartridge which disturbs and increases the temperature of the fluid inside the cartridge/reservoir. For these reasons, a positive displacement-driving mechanism is preferred over the pneumatic-driven mechanism, since the fluid is completely enclosed by the cartridge/syringe which is always in direct contact with the steady temperature of the reservoir block (FIGS. 1 and 2), provided by the Peltier element cooling solution.

Embodiments of the temperature-controlled source well holder 1b, liquid handling and dispensing system 9, apparatus 20 and methods comprising the temperature-controlled source well holder 1b are arranged for control of temperature (<0° C. to 65° C., <0° C. to 10° C., preferably 0° C. to 4° C., or any range in between using any of these endpoints) and volume (2 nL to 10 mL, 5 nL to 5 mL, 10 nL to 3 mL and preferably 10 nL to 0.5 mL) of at least one fluid reservoir/source well located inside at least one temperature-controlled source well holder. Such source well holder is located between at least one pressure-based dispenser and a target well holder. These three components are integrated in a non-contact, high precision liquid handling system. The temperature control range of 0° C. to 10° C. can be used to dispense extracellular matrix-derived solutions (e.g., gelatinous protein mixtures, extracellular matrix proteins in solution, and basement membrane matrices). However, when requiring precise and accurate dispensing of such fluids over a long period of time (>2 hours), a temperature range of 0° C. to 4° C. is better and a temperature range of 0° C. to 2° C. is preferred.

Embodiments provide systems and methods for control of temperature for the target plate holder 12, FIGS. 4, 5 (20° C. to 100° C., 20° C. to 60° C., preferably 20° C. to 40° C., or any range in between using any of these endpoints) to control the gelation of the extracellular matrix-derived solutions once the droplets are collected on the target plate.

The present disclosure provides for a computer program comprising computer-executable instructions, which when the program is executed by a computer, cause the computer to carry out any of the processes, methods, and/or algorithms according to the above. The computer-executable instructions can be programmed in any suitable programming language, including JavaScript, C, C#, C++, Java, Python, Perl, Ruby, Swift, Visual Basic, and Objective C.

Also provided herein is a non-transitory computer-readable medium (or media) comprising computer-executable instructions, which when executed by a computer, cause the computer to carry out any of the processes, methods, and/or algorithms according to the above. As used in the context of this specification, a “non-transitory computer-readable medium (or media)” may include any kind of computer memory, including magnetic storage media, optical storage media, nonvolatile memory storage media, and volatile memory. Non-limiting examples of non-transitory computer-readable storage media include floppy disks, magnetic tape, conventional hard disks, CD-ROM, DVD-ROM, BLU-RAY, Flash ROM, memory cards, optical drives, solid state drives, flash drives, erasable programmable read only memory (EPROM), electrically erasable programmable read-only memory (EEPROM), non-volatile ROM, and RAM. The non-transitory computer readable media can include one or more sets of computer-executable instructions for providing an operating system as well as for implementing the processes, methods, and/or algorithms of the invention.

The present invention has been described with reference to particular embodiments having various features. In light of the disclosure provided above, it will be apparent to those skilled in the art that various modifications and variations can be made in the practice of the present invention without departing from the scope or spirit of the invention. One skilled in the art will recognize that the disclosed features may be used singularly, in any combination, or omitted based on the requirements and specifications of a given application or design. When an embodiment refers to “comprising” certain features, it is to be understood that the embodiments can alternatively “consist of” or “consist essentially of” any one or more of the features. Any of the methods disclosed herein can be used with any of the systems and/or components thereof disclosed herein or with any other systems and/or components thereof. Likewise, any of the disclosed systems and/or components thereof can be used with any of the methods disclosed herein or with any other methods. Other embodiments of the invention will be apparent to those skilled in the art from consideration of the specification and practice of the invention.

It is noted in particular that where a range of values is provided in this specification, each value between the upper and lower limits of that range, to the tenth of the unit disclosed, is also specifically disclosed. Any smaller range within the ranges disclosed or that can be derived from other endpoints disclosed are also specifically disclosed themselves. The upper and lower limits of disclosed ranges may independently be included or excluded in the range as well. The singular forms “a,” “an,” and “the” include plural referents unless the context clearly dictates otherwise. It is intended that the specification and examples be considered as exemplary in nature and that variations that do not depart from the essence of the invention fall within the scope of the invention. Further, all of the references cited in this disclosure are each individually incorporated by reference herein in their entireties and as such are intended to provide an efficient way of supplementing the enabling disclosure of this invention as well as provide background detailing the level of ordinary skill in the art.

1. A temperature-controlled unit for receiving, holding and releasing liquid or semi-liquid material, the unit comprising:
at least one reservoir block, at least one Peltier element, each Peltier element having opposite first and a second surfaces; and
at least one cooling element
wherein the at least one Peltier element is arranged to have each respective first surface facing a reservoir block of the temperature-controlled unit;
wherein the at least one cooling element is thermally connected to the Peltier element and arranged to transfer heat generated by the at least one Peltier element and dissipate the transferred heat away from the at least one Peltier element; and
optionally, wherein temperature of the temperature-controlled unit and/or dispensing contents, such as liquid, semi-liquid, hydrogel and/or reagents, is capable of being maintained within a range of ±0.05 degrees, or ±0.005 degrees, or ±0.01 degrees, or ±0.5 degrees, or ±1.0 degrees, or ±2.0 degrees, or for any range in between, and optionally for any amount of time, such as from above zero seconds up to 1 week, or from 1 second up to 1 month, or from 1 minute up to 24 hours, or from 10 seconds up to 5 days.

2. The temperature-controlled unit according to claim 1,
wherein the cooling element is a heatsink.

3. The temperature-controlled unit according to claim 1 further comprising:
at least one fan, wherein the at least one fan is arranged to transport gas heated by the at least one Peltier element away from the at least one Peltier element.

4. The temperature-controlled unit according to claim 3, wherein:
the at least one fan comprises first and second fans, wherein the first fan is arranged at the bottom side of the heatsink and the second fan is arranged at the top side of the heatsink, and wherein the first fan is arranged to suck in air from the bottom towards the at least one heatsink, through the at least one heat sink, and the second fan is arranged to pull air away from the at least one heatsink.

5. The temperature-controlled unit according to claim 1,
wherein the cooling element is at least one liquid cooling unit comprising a liquid coolant, the liquid cooling unit being arranged to be thermally connected to the Peltier element, and wherein the at least one liquid cooling unit is further arranged to dissipate transferred heat away from the at least one Peltier element by circulating the liquid coolant.

6. The temperature-controlled unit according to claim 5, wherein the liquid coolant comprises at least one of water, deionized water, ethylene glycol solution, and betaine.

7. The temperature-controlled unit according to claim 1, wherein the temperature-controlled unit is capable of controlling the fluid temperature in the range of <0° C. to 65° C., <0° C. to 37° C., such as from −20° C. to 20° C., or from −10° C. to 5° C., or from 0.5° C. to 6° C., and preferably 0° C. to 4° C. for at least 10 seconds to at least 24 hours or more and preferably up to at least 12 hours, or for any amount of time in between or more, such as for any fixed amount of time.

8. The temperature-controlled unit according to claim 1, wherein:
the liquid or semi-liquid material the temperature-controlled unit is arranged to receive, hold and release extracellular matrix-derived solutions such as but not limited to (a) gelatinous protein mixtures, (b) extracellular matrix proteins in solution, and/or (c) basement membrane matrices.

9. The temperature-controlled unit according to to claim 1, wherein the temperature-controlled unit is a dispensing head.

10. The temperature-controlled unit according to claim 9, wherein the dispensing head is a positive displacement dispensing head arranged to control (a) temperature (<0° C. to 65° C., <0° C. to 10° C., such as from −20° C. to 20° C., or from −10° C. to 5° C., or from 0.5° C. to 6° C., or from 0° C. to 37° C., preferably 0° C. to 4° C., or any range in between using these endpoints), (b) volume (10 nL to 10 mL, preferably 1 μL to 100 μL) and (c) flow rate (0.1 μL/s to 40 μL/s, preferably 1 μL/s to 20 μL/s) for dispensing small volumes with high accuracy and precision) of the fluid being dispensed.

11. The temperature-controlled unit according to claim 9, wherein the dispensing head is an inkjet driven dispensing head arranged to control (a) temperature (<0° C. to 65° C., <0° C. to 10° C., such as from −20° C. to 20° C., or from −10° C. to 5° C., or from 0.5° C. to 6° C., or from 0° C. to 37° C., preferably 0° C. to 4° C., or any range in between using these endpoints) and volume (2 nL to 10 mL, preferably 10 nL to 100 μL) of the fluid being dispensed.

12. The temperature-controlled unit according to claim 1, wherein the temperature-controlled unit is a source well holder arranged to hold at least one source well arranged for receiving a temperature-sensitive liquid and from which the liquid is dispensed, the source wells being open at an upper end, wherein respective bases opposite the upper end have an orifice, where the orifice is configured in such a manner that capillary pressure in the respective orifice is greater than a pressure which can be produced by the liquid in the respective source well.

13. The temperature-controlled unit of claim 12, wherein the source well holder is capable of controlling (a) temperature (<0° C. to 65° C., <0° C. to 10° C., such as from −20° C. to 20° C., or from −10° C. to 5° C., or from 0.5° C. to 6° C., or from 0° C. to 37° C., preferably 0° C. to 4° C.), or any range in between using these endpoints and (b) volume (2 nL to 10 mL, 5 nL to 5 mL, 10 nL to 3 mL and preferably 10 nL to 0.5 mL) for dispensing small volumes with high accuracy and precision of the fluid being dispensed.

14. The temperature-controlled unit of claim 12, wherein the source well holder comprises at least one non-contact, pressure-driven, immediate drop on demand technology capable of controlling (a) temperature (<0° C. to 65° C., <0° C. to 10° C., such as from −20° C. to 20° C., or from −10° C. to 5° C., or from 0.5° C. to 6° C., or from 0° C. to 37° C., preferably 0° C. to 4° C., or any range in between using these endpoints) and volume (2 nL to 10 mL, preferably 10 nL to 100 μL) of the fluid being dispensed.

15. A liquid handling and dispensing system for regulating a temperature of a temperature-controlled unit, the automated liquid handling and dispensing system comprising:
a temperature-controlled unit arranged for receiving, holding and releasing liquid or semi-liquid material according to claim 1;
a dispensing chamber,
wherein the temperature-controlled unit is arranged inside the dispensing chamber.

16. The liquid handling and dispensing system according to claim 15, wherein:
the dispensing chamber is small enough to be placed inside a standard Laminar Flow Hood bench for operation in sterile environment;
the size of the liquid handling and dispensing system is less than 1 m³, less than 0.125 m³ (0.5×0.5×0.5 m) and preferably less than 0.043 m³ (0.35×0.35×0.35 m).

17. A method for regulating a temperature of a temperature-controlled unit arranged for receiving, holding and releasing liquid or semi-liquid material, the method comprising:
providing one or more temperature-controlled units arranged for receiving, holding and releasing liquid or semi-liquid material comprising:
at least one Peltier element, one or more or each Peltier element having opposite first and second surfaces; and
at least one cooling element,
wherein the at least one Peltier element is arranged to have one or more or each respective first surface facing a reservoir block,
wherein the at least one cooing element is thermally connected to one or more of the Peltier elements and is arranged to transfer an amount of heat generated by the at least one Peltier element and to dissipate at least a portion of the transferred heat away from the at least one Peltier element,
applying to at least one of the Peltier elements, a first voltage having a first polarity, the first voltage being arranged to cause a temperature at the first surface of at least one of the at least one Peltier elements to decrease.

18. The method according to claim 17, further comprising a step of:
applying to at least one of the Peltier elements, a second voltage having a second polarity, the second voltage being arranged to cause a temperature at the first surface of at least one of the at least one Peltier elements to increase.

19. A computer program comprising computer program code which, when executed, causes a temperature-controlled unit according to claim 1 to carry out a method for regulating a temperature of a temperature-controlled unit arranged for receiving, holding and releasing liquid or semi-liquid material, optionally by comparing a target temperature to a measured temperature in the reservoir block by a temperature sensor.

20. An apparatus for applying temperature-sensitive liquids on one or more target plates, comprising:
a temperature-controlled source well holder of claim 12;
a mechanism for producing a gas pressure pulse disposed above the source well holder and in fluid communication with the respective upper end of at least one or several but not all of the source wells to receive the gas pressure pulse;
a holder for at least one target plate capable of being disposed below the temperature-controlled source well holder;
at least one moving mechanism for moving or rotating the source well holder relative to the at least one element producing a gas pressure pulse, and/or vice versa; and
at least one moving mechanism for moving the target plate holder relative to the at least one source well holder, and/or vice versa.

21. The apparatus according to claim 20, wherein the target plate is at least one of: a glass slide, a biochip, a microtiter plate, and/or a microarray.

22. The apparatus according to claim 20, wherein at least two of the holders for the source wells, and the holder for at least one target plate are displaceable independently of each other with respect to the mechanism for producing a gas pressure pulse, at least one of horizontally and vertically, by a moving mechanism.

23. The apparatus according to claim 20, wherein the mechanism for producing a gas pressure pulse is displaceable vertically by a moving mechanism in such a manner that at least one, several or all of the source wells are simultaneously or sequentially or in any order supplied with a gas pressure pulse by the mechanism for producing a gas pressure pulse.

24. The apparatus according to claim 20, wherein the mechanism for producing a gas pressure pulse comprises at least one plunger and/or piston.

25. The apparatus according to claim 24, wherein the plunger includes a contact face that contacts the source well, and the contact face includes a seal in the form of a sealing ring and/or a sealing disc.

26. The apparatus according to claim 24, wherein the plunger is a pneumatically driven plunger.

27. The apparatus according to claim 20, wherein the target plate holder is capable of controlling the target plate temperature in the range of 20° C. to 100° C., 20° C. to 60° C., such as from 20° C. to 80° C., or from 20° C. to 50° C. and preferably 20° C. to 37° C. for at least 10 seconds to at least 24 hours or more and preferably up to at least 12 hours, or for any amount of time in between or more, such as for any fixed amount of time.

28. A method for applying liquids on target plates, comprising:
simultaneously supplying at least one source well with a pressure pulse by a mechanism for producing a pressure pulse, wherein: a temperature-controlled source well holder includes one or more source wells for receiving a liquid and from which the liquid is dispensed, the source well holder comprising a plurality of source wells that are open at an upper end, wherein respective bases opposite the upper end have an orifice, where the orifice is configured in such a manner that capillary pressure in the respective orifice is greater than a pressure which can be produced by the liquid in the respective source well; a mechanism for producing a gas pressure pulse disposed above the source well holder and in fluid communication with the respective upper end of at least one or several but not all of the source wells to receive the gas pressure pulse; a holder for at least one target plate is disposed below temperature-controlled source well holder; at least one moving mechanism for moving or rotating the source well holder relative to the at least one element producing a gas pressure pulse; and at least one moving mechanism for moving the target plate holder relative to the at least one source well holder.

29. The method according to claim 28, further comprising controlling a volume of the liquid applied on the target plate by means of at least one of: the pressure pulse, a length of the pressure pulse, and a number of pressure pulses.

30. The method according to claim 28, further comprising: producing the pressure pulse by means of a quick-acting valve or a mechanical movement of a piezoactuator.

31. The method according to claim 28, further comprising: producing the pressure pulse by means of air or a piston movement.
